(19) United States
(12) Patent Application Publication
(10) Pub. No.: US 2019/0188332 A1
(43) Pub. Date: Jun. 20, 2019

(54) SYSTEM OF DYNAMIC KNOWLEDGE GRAPH BASED ON PROBABALISTIC CARDINALITIES FOR TIMESTAMPED EVENT STREAMS

(71) Applicant: Mito.AI AS, Trondheim (NO)

(72) Inventors: Jon Espen Ingvaldsen, Trondheim (NO); Patrick Skjennum, Trondheim (NO)

(21) Appl. No.: 15/844,159

(22) Filed: Dec. 15, 2017

(51) Int. Cl. G06F 17/30; G06N 7/00; G06F 17/27

(52) U.S. Cl. CPC G06F 17/30958; G06F 17/2785; G06F 17/278; G06N 7/005

(57) ABSTRACT

Methods and systems are provided for constructing knowledge graphs and their underlying ontologies from scratch and dynamically updating them based on one or more event streams corresponding to a given knowledge domain by utilizing probabilistic cardinalities corresponding to entities associated to timestamped events from observed event streams. Snapshots of the knowledge graph at a select past time are provided, as are time series forecasts up to a select future time on entities of a relevant ontology.

### BACKGROUND OF THE DISCLOSURE

The present disclosure relates in general to knowledge management and engineering, and particularly to knowledge graphs and underlying ontologies. Specifically, the present disclosure relates to systems and methods for constructing knowledge graphs and their underlying ontologies and dynamically updating them based on probabilistic cardinalities for timestamped event streams.

Knowledge graphs have been utilized to organize and present large networks of entities or concepts, their semantic types, properties and relationships in various knowledge domains and cross-domain spaces. In recent years, several large knowledge graphs have been created in different manners. Some are curated (e.g., Cyc, Lenat, et al., AI Magazine 6.4 (1985): 65); others are edited by crowd (e.g., Wikidata, Vrandečić, Proceedings of the 21st International Conference on World Wide Web, ACM, 2012; Vrandečić & Krötzich, Comnunications of the ACMS7.10 (2014): 78-85); and still others extracted from large-scale, semi-structured web knowledge bases (e.g., DBpedia; Auer, et al., The semantic web (2007): 722-735; Lehmann, et al., Semantic Web 6.2 (2015): 167-195; YAGO, Mahdisoltani et al., 7th Biennial Conference on Innovative Data Systems Research, CIDR Conference, 2014; Suchanek, “The YAGO Knowledge Base.” (2016).) Increasingly knowledge graphs are also becoming core assets of organizations, whether governmental, non-governmental or commercial. Some examples of proprietary knowledge graphs include Google Knowledge Graph, Microsoft Satori, and Facebook's Entity Graph.

Due to their abilities to represent semantics and meaning, knowledge graphs are a powerful tool to procure and organize knowledge and derive information or intelligence regarding a particular topic or domain. Any topic area may refer to its own knowledge domain. A knowledge graph often has an underlying ontology corresponding to a particular knowledge domain. Ontologies represent substantive concepts, entities and their relationships in and relating to their corresponding knowledge domains. Knowledge graphs and ontologies can vary widely across different knowledge domains with respect to size, structure, process, utility and applications. However, existing ontologies and knowledge graphs tend to be formalistic and static, lacking in the capacity to evolve over time and the option to provide time-specific insight into aspects of the corresponding domains. Additionally, handling large volumes of new data or events efficiently and differentiating relevant information and noise remains a significant challenge to the construction of knowledge graphs and ontologies for particular knowledge domains.

There is therefore a need for improved systems and methods to provide dynamic knowledge graphs and underlying ontologies adapted to evolve over time in view of changing circumstances of a knowledge domain of interest. There is also a need for time-specific insight into aspects of an interested domain as represented by a knowledge graph and its ontology.

### SUMMARY OF THE VARIOUS EMBODIMENTS

It is therefore an object of this disclosure to provide systems and methods for constructing knowledge graphs and their underlying ontologies and dynamically updating them based on one or more event streams corresponding to a given knowledge domain by utilizing probabilistic cardinalities corresponding to entities associated to timestamped events of event streams.

Particularly, in accordance with this disclosure, there is provided, in one embodiment, a system of dynamic knowledge graph that comprises: i) a cardinality approximator adapted to process a plurality of events thereby estimating probabilistic cardinalities for the plurality of events; and, ii) a graph database adapted to provide an ontology for a knowledge domain corresponding to the plurality of events and to store information regarding the knowledge domain. Each event in the plurality is associated with a timestamp, and the graph database is continuously updated based on the plurality of events.

In another embodiment, the ontology for the knowledge domain is initially imported to the graph database. In yet another embodiment, the ontology is initially constructed from processing the plurality of events.

In a further embodiment, the plurality of events comprises a first stream of events sequentially observed. The cardinality approximator is adapted to calculate the probabilistic cardinalities for the first stream of events.

In another embodiment, the plurality of events further comprises a second stream of events sequentially observed. The cardinality approximator is further adapted to calculate the probabilistic cardinalities for the second stream of events.

According to yet another embodiment, the cardinality approximator utilizes one of Hyper LogLog, Hyper LogLog++, Sliding Hyper Log Log, and Log Log.

According to a further embodiment, the event is associated with at least one entity recognized by the ontology. The probabilistic cardinalities for the plurality of events comprises a probabilistic cardinality for the entity.

In another embodiment, the graph database is further adapted to evolve the ontology by incorporating a previously-unrecognized entity associated with a timestamped event of the plurality. The cardinality approximator is further adapted to estimate a probabilistic cardinality for the previously-unrecognized entity.

In yet another embodiment, the system further comprises an event archive adapted to store information regarding the plurality of events.

According to a further embodiment, the knowledge domain consists of one of the financial information domain, the social media domain, the e-commerce domain, the law enforcement domain, the manufacturing and labor inspection domain, the medical and pharmaceutical domain, and climate sciences domain.

In another embodiment, the system further comprises a graph analytics module adapted to traverse the graph database and identify entities and relationships based on probabilistic cardinalities.

In yet another embodiment, the graph analytics module is further adapted to generate a snapshot of the graph database at a predetermined time in the past.

In a further embodiment, the graph analytics module is further adapted to generate a time series on an entity of the ontology thereby estimating a trend up to a predetermined time in the future for the entity.

According to another embodiment, the system further comprises a user interface adapted to present content to a user, where the content is one of text, graphic, voice, and multi-media. In a further embodiment, the user interface is adapted to receive a query from the user, and the content is a response to the query.

In yet another embodiment, the user interface is one of a smart phone, an AR/VR device, a web browser, and a robotic assistant.

In accordance with this disclosure, there is provided, in another embodiment, a method for dynamically updating a knowledge graph based on an underlying ontology for a knowledge domain. The method comprises: i) collecting a plurality of events corresponding to the knowledge domain, where each event in the plurality has a timestamp and is associated with at least one entity recognized in the ontology; ii) estimating a probabilistic cardinality for the at least one entity associated with each event in the plurality: and, iii) updating the knowledge graph by incorporating the corresponding probabilistic cardinalities for the entities recognized in the ontology.

In yet another embodiment, the method further comprises incorporating a previously-unrecognized entity associated with a timestamped event of the plurality and estimating a probabilistic cardinality for the previously-unrecognized entity, thereby updating the ontology of the knowledge domain.

In a further embodiment, collecting a plurality of events further comprises collecting a first stream of events sequentially observed based on their corresponding timestamps, where the knowledge graph is continually updated based on the first stream of events.

In another embodiment, the method further comprises collecting a second stream of events sequentially observed based on their corresponding timestamps, where the knowledge graph is continually updated based on the first and the second streams of events.

In a further embodiment, the method further comprises generating a snapshot of the knowledge graph at a predetermined time in the past.

In another embodiment, the method further comprises generating a time series on an entity of the ontology thereby estimating a trend up to a predetermined time in the future for the entity.

### BRIEF DESCRIPTION OF THE DRAWINGS

FIG. 1 depicts an example temporal snapshot of a dynamic knowledge graph regarding the automotive industry according to one embodiment of this disclosure.

FIG. 2 illustrates data flow in a system of a dynamic knowledge graph according to one embodiment.

FIG. 3 depicts a fragmented domain ontology for infectious diseases according to one embodiment.

FIG. 4 depicts a fragmented domain ontology for infectious diseases as shown in FIG. 3 updated based on relevant events observed according to one embodiment.

FIG. 5 depicts a part of a domain ontology for manufacturing and labor inspection including accident data according to one embodiment.

FIG. 6 depicts a part of a domain ontology for manufacturing and labor inspection as shown in FIG. 5 updated based on relevant events observed according to one embodiment.

FIG. 7 illustrates a time series of a dynamic knowledge graph for sales in a coffee café according to one embodiment. FIG. 7(a) illustrates a time series over a year for sales of certain beverage and food products. FIG. 7(b) illustrates the coordination in the sales data among several products over time based on probabilistic cardinalities estimated in the dynamic knowledge graph system of one embodiment.

FIG. 8 illustrates two snapshots at specific time points based on FIGS. 7(a) and (b), showing evolving entities and relationships over time in one embodiment.

FIG. 9 is a table listing examples of events relevant for particular knowledge domains according to various embodiments.

### DETAILED DESCRIPTION OF THE VARIOUS EMBODIMENTS

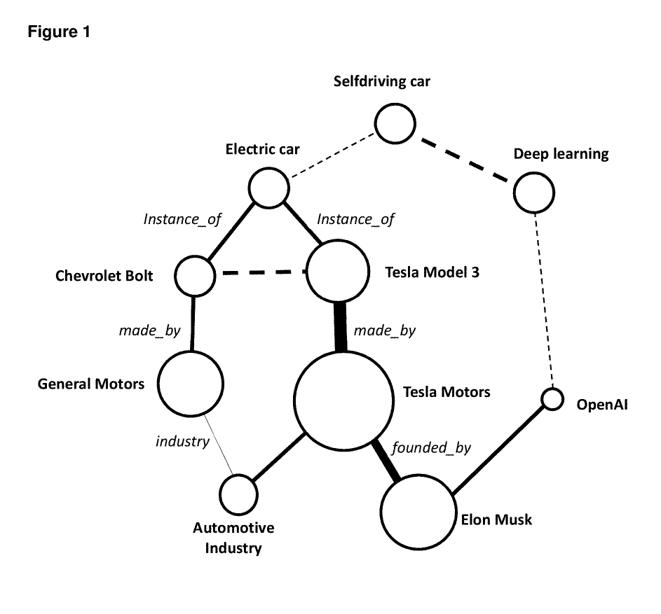

Referring to FIG. 1, a temporal snapshot of a dynamic knowledge graph regarding the automotive industry is shown according to one embodiment of this disclosure. The nodes represent entities in the knowledge domain of automotive industry, and the edges represent relations or associations between and among the entities. The solid lines represent known or existing relations recognized in the underlying domain ontology. The dashed lines represent relations discovered or added based on event observations and by processing new information fed to the system via event streams. In this example, the relevant events include news articles referencing entities of interest in this particular knowledge domain. The radius of the nodes and the width of the edges shown are utilized to represent event-based cardinality estimates made by the system according to one embodiment. For example, the entity “Tesla Motors” is shown as the largest node in this graph, which indicates that the system recognizes this entity with high popularity or visibility. Similarly, the edge “made by” between “Tesla Model S” and “Tesla Motors” is shown as the thickest edge in this graph, which indicates that the system determines the “made by” relation between “Tesla Model S” and “Tesla Motors” with high confidence or interest level in the domain.

Throughout this disclosure in various embodiments, the terms “relations,” “associations,” “relationships,” “interrelationship,” and “associative relationships” are used interchangeably to describe the ways in which entities are related to one another directly or indirectly.

### System of Dynamic Knowledge Graph

An exemplary dynamic knowledge graph system of this disclosure comprises a cardinality approximator adapted to provide probabilistic cardinality estimations for relevant entities in the knowledge graph, and a graph database adapted to provide an ontology for the corresponding knowledge domain which describes relevant entities and relationships or associations among them.

In addition, a dynamic knowledge graph system in one embodiment comprises a plurality of events representing new information being processed by the system thereby enabling the knowledge graph and its underlying ontology to be updated continuously. The plurality of events are one or more streams of events according to various embodiments, each of the streams being sequentially organized. Importantly, event streams comprise timestamped events according to one embodiment, providing the dynamic knowledge graph system of this disclosure with a temporal dimension in which to present and analyze relevant entities and relations or associations among them.

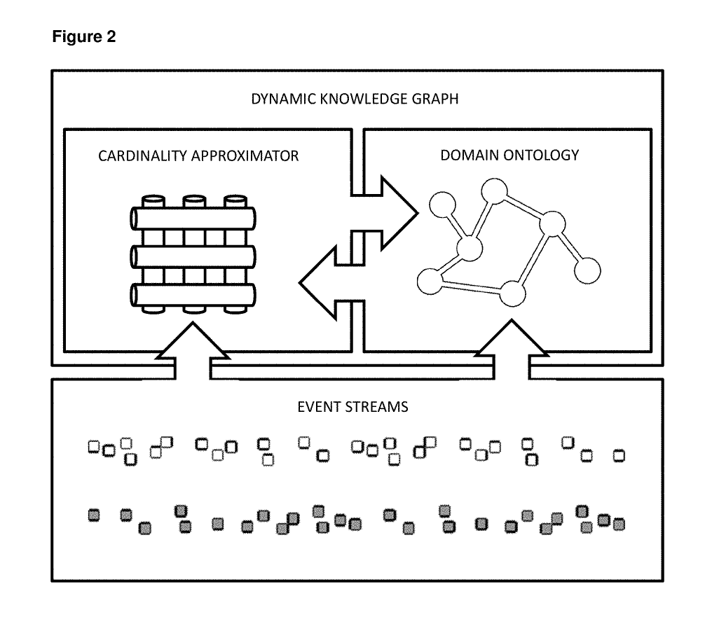

Referring to FIG. 2, data flows in a system of dynamic knowledge graph according to one embodiment is demonstrated. The dynamic knowledge graph system as shown comprises a cardinality approximator and a graph database containing the relevant domain ontology, both of which are connected to event streams in the system and receive data flows therefrom. Two-way data flows between the cardinality approximator and the domain ontology or graph database are also enabled in this dynamic system as shown.

As discussed above, the domain ontology describes knowledge entities, structures and relationships. The cardinality approximator is adapted to provide probabilistic cardinality estimates, which are utilized in assigning entities and relations with weight or significance and confidence levels based on temporal and other elements derived from information captured in the domain ontology and from new event observations.

The dynamic aspect of the system is demonstrated by the free exchange of data between the underlying domain ontology of the graph database and the cardinality approximator, as well as by the continuous data flows into the domain ontology and the cardinality approximator, respectively, from event streams. In one embodiment, the dataflow feeds event observations to the cardinality approximator for calculating temporal weights or significance levels of relevant entities and relations. In another embodiment, the dataflow into the domain ontology allows the domain ontology to be updated with new entities and relations or associations, thereby expanding the knowledge domain with new knowledge structures.

### Domain Ontologies

As discussed above, the dynamic knowledge graph system of this disclosure comprises a graph database which has an underlying ontology corresponding to a relevant knowledge domain. Ontologies and domain ontologies are used interchangeably in this disclosure. An ontology typically embodies the definition of types, properties, and interrelationships of entities or concepts in a knowledge domain. Examples of ontologies including ontologies for the financial information domain, the social media domain, the e-commerce domain, the law enforcement domain, the manufacturing and labor inspection domain, the medical and pharmaceutical domain, and the climate sciences domain.

In some embodiments, domain ontology and graph database are used interchangeably; for clarity the former focuses on the substantive concepts and relationships of the entities while the latter focuses on the database structure that supports or stores the substantive concepts and relationships embodying the ontology. The graph database may be queried by a user to extract information on the domain ontology in a dynamic knowledge graph system of this disclosure as discussed in detail below.

A domain ontology is constructed from scratch according to a certain embodiment of this disclosure. Entity and relationship values are constructed based on event observations from the event streams connected into the dynamic knowledge graph system. Over time and based on the volume of events processed by the system, the domain ontology expands and enriches in its content and complexity. In an alternative embodiment, a domain ontology is imported initially to a system of dynamic knowledge graph, and is updated continuously over time based on event observations from the event streams.

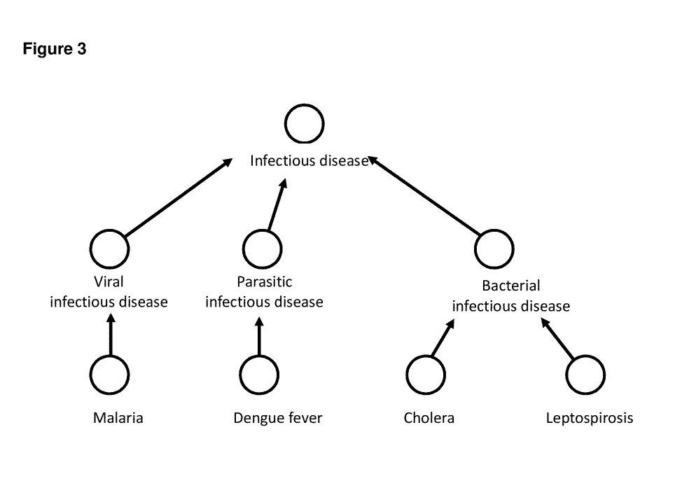

Referring to FIG. 3, a fragmented domain ontology for infectious diseases is shown according to one embodiment. The nodes in this graph represent diseases and disease categories. The edges represent relations or relationships, such as “is-a.”

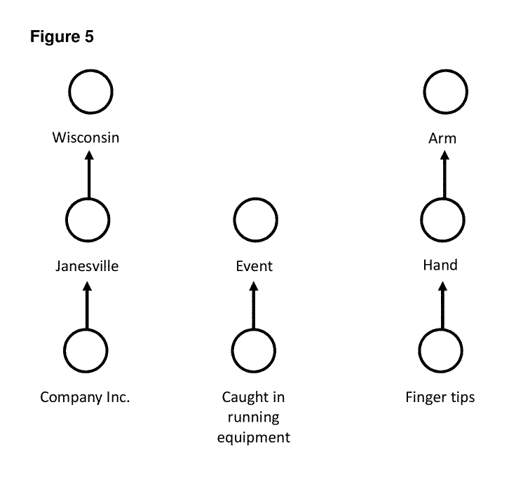

Referring to FIG. 5, a fragmented domain ontology for manufacturing and labor inspection is shown according to one embodiment. This ontology describes companies, relevant accident types and event categorizations, and body parts and related associations. The nodes in this graph represent concepts in this ontology, while the edges represent relevant relations or associations, such as “located-in,” “is-a,” and “part-of.”

### Event Streams

An event stream is a continuing flow of data events running through a system. An event stream is organized sequentially over time according to one embodiment. Multiple event streams may reference different temporal measures in various embodiments. An event stream may experience pause or suspension at certain time points in certain embodiments. Duplicative events; multiple events of the same nature may present in one or more event streams. The system according to a certain embodiment is adapted to validate raw event submissions and ignore any unwanted event repeats. In another embodiment, the system of this disclosure is adapted to accept legitimate duplicative events and update cardinalities of the related entities and relations accordingly. Event streams may adopt varied speed and event occurrence may adopt various frequencies according to alternative embodiments of this disclosure.

An event as represented in a dynamic knowledge graph system of this disclosure comprises various data fields, including an event identifier, one or more entity identifiers for referenced-entities, and a timestamp among other fields, specific to a corresponding knowledge domain. Examples of event streams and timestamped events according to various embodiments include among others patient records, phone call records, e-commerce transactions, Tweets, news articles, daily weather reports, annual hurricane reports, stock trading data, and clinical trials reports; each corresponding to an applicable knowledge domain.

In one embodiment, multiple event streams constitute a plurality of events for a continuously-updated knowledge graph system. Such event streams may present large data volumes and high data velocity. The system of this disclosure allows highly efficient processing of high-volume and high-speed event streams by applying designated probabilistic cardinality estimation algorithms of the cardinality approximator as discussed in detail below. The flexible data connections among the cardinality approximator, the domain ontology, and the event streams further facilitate the efficiency of updates in the dynamic knowledge graph system.

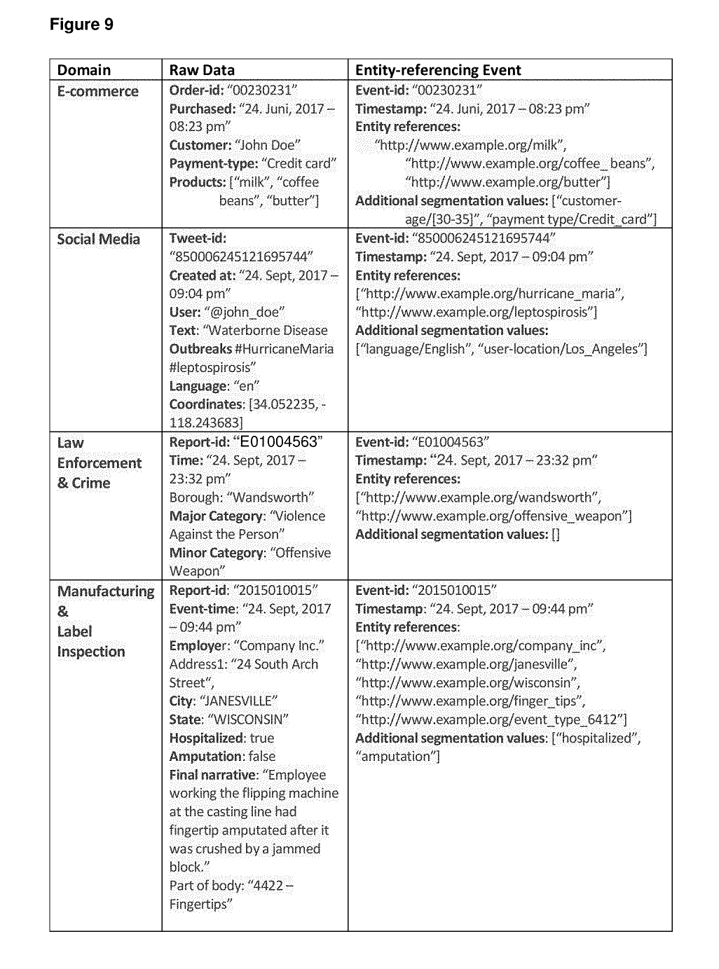

Referring to FIG. 9, examples are listed in a table for raw data and the corresponding processed entity-referencing events from event streams corresponding to a relevant knowledge domain. Specifically, a variety of distinct data fields are utilized to present and capture information relevant for events corresponding to different domains including e-commerce (an online order transaction), social media (a Twitter message), law enforcement & crime (a police call), and manufacturing and labor inspection (an accident report), respectively.

Events of the dynamic knowledge graph system according to one embodiment are entity-referencing events. An entity-referencing event has one unique identifier, one primary timestamp, one or more entities recognized in the underlying domain ontology, and additional segmentation values. All values are derived from field values in the raw event stream data and mapped to the processed entity-referencing events. For example, referring to the Twitter event in the table of FIG. 9, the hash-tagged terms are extracted and matched against a domain ontology and with its relevant entities, e.g., “hurricane_maria” and “leptospirosis.”

In addition, numeric values are gathered, discretized, and incorporated as segmentation values where applicable. For example, referring to the online shopping event in the table of FIG. 9, the age of the customer is collected from an external source and deemed as relevant to the domain. It is accordingly discretized and incorporated as a segmentation value as shown here. The mapping logic applied as event observations are processed by the system are domain- and application-specific according to various embodiments.

### Probabilistic Cardinalities

The dynamic knowledge graph system of this disclosure comprises a cardinality approximator as discussed above. The cardinality approximator applies probabilistic cardinality estimation algorithms to determine the probabilistic cardinalities of sets relating to relevant entities and relationships with a significate degree of accuracy. According to various embodiments, several probabilistic cardinality estimation algorithms are applied, including e.g., Hyper LogLog (Flajolet, et al., Analysis of Algorithms, Discrete Mathematics and Theoretical Computer Science, 2007) (“HLL”): Hyper LogLog++ (Heule, et al., Proceedings of the 16th International Conference on Extending Database Technology, ACM, 2013) (“HLL++”); Sliding HyperLogLog (Chabchoub & Hébrail, Data Mining Workshops (ICDMW), 2010 IEEE International Conference) (“Sliding HLLs”); and LogLog-Beta (Qin, et al., arXiv preprint arXiv:1612.02284 (2016)) (“LL Beta”).

HLL and HLL++ are commonly applied, while HLL++ provides improved storage efficiency and lower number estimation for the cardinality approximator in one embodiment. In another embodiment, Sliding HLLs is applied to incorporate time ranges in the count estimates. The cardinality approximator of various embodiments creates HLL variables for all entity-referencing values and for discretized segmentation and timestamp values. The pseudo-code below is an example showing how data values are added to the two HLL variables “visitors” and “customers”:

> ADD visitors “alice”, “bob”, “carol”, “alice”
> COUNT visitors
3
> ADD customers “alice”, “dan”
> MERGE everyone visitors customers
> COUNT everyone
4

When the count operation is executed as shown here, a count estimate of the number of unique values are returned for each HLL variable. The merge operation enables the construction of a new HLL variable approximating the cardinality of the union of two or more existing HLLs. Here, “everyone” is the new HLL variable that accounts for all “visitors” and “customers.” In certain embodiments on-the-fly merge operations are incorporated in the count operation.

As timestamped events run through the knowledge graph system, therefore, the cardinality approximator provides count estimates and temporal statistics for the concepts and relationships central to the dynamic knowledge graph system. The cardinality approximator is structurally and computationally coupled to the graph database and its underlying domain ontology, as shown in FIG. 2, and is a dynamic part of the knowledge graph system of this disclosure. The count estimates and temporal statistics generated by the cardinality approximator are in turn utilized to represent and validate the weight or significance levels of relevant entities and associations in the domain ontology as the latter continuously evolves in the knowledge graph system according to various embodiments.

### Event-Driven Ontology Update

As discussed above, the knowledge graph system of this disclosure is dynamic as the underlying domain ontology continuously evolves and enriches based on event observations. Event-driven updates to the domain ontology is the key to this feature of the system.

A single event stream or multiple parallel event streams may be connected and fed into the system for a given time period in alternative embodiments, providing new and updated entity and relationship information. The timestamp and discretized field values for each event are then added to HLLs by the cardinality approximator. Event information for each event is stored in an event archive according to a further embodiment. The event archive forms a part of the knowledge graph system and is coupled to the event streams in this embodiment.

According to one embodiment, the entity-referencing events are utilized as input to construct ontological structures and expand or enrich the content and structure of the existing domain ontology of the system. In a certain embodiment, this is a scheduled batch operation, where all or a subset of the events are read and processed. For example, from each event record, the set of ontology relevant fields and values are extracted. The frequency of entity-referencing values and their pairwise co-referencing combinations are counted. Field values and value combinations above a predetermined minimum threshold are deemed as relevant to the domain ontology; and, the corresponding entities and associations are in turn selected as new entities and new associations to be added to the existing domain ontology. In an alternative embodiment, this operation is event-by-event automatically undertaken by the system as each event arrives over the event streams.

Referring to FIG. 9, the Twitter event listed, for example, the hashtagged fields regarding hurricanes are relevant to the domain ontology of interest there. Events like this are used to update and enrich the domain ontology with associative relationships. By counting how frequent these entity-referencing values occur separately and together, and determine which values are above a predetermined minimum count threshold, the strengths of associations are measured and input into the domain ontology. In certain embodiments, distance functions such as conditional probability. Normalized Google Distance, and Jaccard similarity are utilized to measure the strengths of associations.

Each event is also added to the HLL structures by the cardinality approximator as it is observed from the event streams in another embodiment. Each discretized field value of the events is connected to one HLL, and the field-value pair forms a HLL variable. For example, with respect to a shopping event involving customers, several HLLs are constructed, for “customer.John_Doe”, “payment_type:MasterCard”, “product:coffee”, “product:milk”, and “product:bread,” respectively. For each of these HLLs, an event-id-value is added for each observed event. An event-id “order-xxxxxxx” is added for this event to the several HLLs created here. As event streams run through the system and are being processed, new and empty HLLs are constructed on-the-fly by the cardinality approximator if one suitable is not already available in the system.

As discussed above, the knowledge graph system of this disclosure and its underlying domain ontology has a certain temporal awareness as it is open to evolving over time based on event observations. Timestamp values of events are added to the HLL structures by the cardinality approximator. Sliding HLL is applied in one embodiment, where time ranges are utilized in the count estimates. HLL and HLL++ are applied in other embodiments, where time values are discretized into buckets of time-periods (e.g., day or year) and used just as any other event field value. In those cases, for example, using daily buckets, a HLL for timestamp:24-06-2017 may be created and an event-id “order-xxxxxxx” may be added to it.

In sum, HLLs as applied by the cardinality approximator in various embodiments store and process large volumes of event data, and thereby enable the estimation of field value observations (such as the number of MasterCard payments or the number of coffees sold). The merge-capabilities of HLLs enable additional and more complex analytics as well (such as the query regarding the number of coffees purchased with MasterCard on the Christmas eve).

Below is a detailed example of event-driven updates to the domain ontology of the knowledge graph system. The events in this example are Tweets observed during a hurricane and an outbreak of bacterial infections.

I. Tweets (Raw Event Data Input).

| | | | Geo- | |
|---|---|---|---|---|
| Tweet id | Timestamp | Text | coordinates | Language |
| 850006245121695744 | “24, Sept, | Waterborne Disease | 34.052235, −118.243683 | en |
| | 2017-09:04 | Outbreaks #HurricaneMaria | | |
| | pm” | #leptospirosis | | |
| 850006245121695764 | “24. Sept, | With the rainy season, | 18.466333, −66.105721 | en |
| | 2017- | #Caribbeanislands face | | |
| | 10:20 pm” | #Leptospirosis | | |
| 850006245121695801 | “24. Sept, | 21% of patients with | 34.052235, −118.243683 | en |
| | 2017-10:24 | #leptospirosis experienced a | | |
| | pm” | #Herxheimer reaction (fever) | | |
| | | after #antibiotic treatment. | | |
| 850006245121695882 | “25. Sept, | Infecciones que puede | 18.129539, −65.443840 | es |
| | 2017-06:02 | obtener de #flooding: | | |
| | am” | #cholera, #leptospirosis, | | |
| | | #malaria, #dengue | | |
| | | #WestNileFever. | | |
| 850006245121695951 | “25, Sept, | Should have seen this coming - | 18.129539, −65.443840 | en |
| | 2017-06:22 | suspected #leptospirosis | | |
| | am” | cases increase in | | |
| | | #PuertoRico after | | |
| | | #HurricaneMaria | | |

II. Tweets Converted to Entity-Referencing Events.

| | | | Additional |
|---|---|---|---|
| Event-id | Timestamp | Entity References: | segmentation values |
| 850006245121695744 | “24. Sept, | http://www.example.org/hurricane_maria, | language/English, |
| | 2017- | http://www.example.org/leptospirosis, | user- |
| | 09:04 pm” | | location/Los_Angeles |
| 850006245121695764 | “24. Sept, | http://www.example.org/carribian_islands, | language/English, |
| | 2017- | http://www.example.org/leptospirosis | user- |
| | 10:20 pm” | | location/San_Juan |
| 850006245121695801 | “24. Sept, | http://www.example.org/leptospirosis, | language/English, |
| | 2017- | http://www.example.org/herx_heimer, | user- |
| | 10:24 pm” | http://www.example.org/antibiotics, | location/Los_Angeles |
| 850006245121695882 | “25. Sept, | http://www.example.org/flood | language/Spanish, |
| | 2017- | http://www.example.org/cholera, | user- |
| | 06:02 am” | http://www.example.org/leptospirosis, | location/Vieques |
| | | http://www.example.org/malaria, | |
| | | http://www.example.org/dengue, | |
| | | http://www.example.org/west_nile_fever | |
| 850006245121695951 | “25. Sept, | http://www.example.org/leptospirosis, | language/English, |
| | 2017- | http://www.example.org/puerto_rico, | user- |
| | 06:22 am” | http://www.example.org/hurricane_maria | location/Vieques |

III. Probabilistic Cardinality Estimation by Cardinality Approximator.

a. Probabilistic Cardinality Estimation Variables Created for Direct Entity References (these Entities are Recognized in the Existing Domain Ontology).

| HLL Variables (relating to entity references) | Event Ids |
|---|---|
| http://www.example.org/hurricane_maria | 850006245121695744, |
| | 850006245121695951 |
| http://www.example.org/leptospirosis | 850006245121695744, |
| | 850006245121695764, |
| | 850006245121695801, |
| | 850006245121695882, |
| | 850006245121695951 |
| http://www.example.org/carribian_islands | 850006245121695764 |
| http://www.example.org/herx_heimer | 850006245121695801 |
| http://www.example.org/antibiotics | 850008245121695801 |
| http://www.example.org/flood | 850006245121695882 |
| http://www.example.org/cholera | 850006245121695882 |
| http://www.example.org/malaria | 850006245121695882 |
| http://www.example.org/dengue | 850006245121695882 |
| http://www.example.org/west_nile_fever | 850006245121695882 |
| http://www.example.org/puerto_rico | 850006245121695951 |

b. Probabilistic Cardinality Estimation Variables Created for Indirect Entity References (these Entities are Added in the Existing Domain Ontology).

| HLL Variables (relating to indirect entity | |
|---|---|
| references) | Event Ids |
| http://www.example.org/infectious disease | 850006245121695744, |
| | 850006245121695764, |
| | 850006245121695801, |
| | 850006245121695882, |
| | 850006245121695951 |
| http://www.example.org/parasitic_infectious | 850006245121695882 |
| disease | |
| http://www.example.org/viral_infectious | 850006245121695882 |
| disease | |
| http://www.example.org/bacterial_infectious | 850006245121695744, |
| disease | 850006245121695764, |
| | 850006245121695801, |
| | 850006245121695882, |
| | 850006245121695951 |

c. Probabilistic Cardinality Estimation Variables Created for Time Range Segmentation (where HLL and HLL++ Structures are Applied).

| HLL Variables (relating to time-range | |
|---|---|
| segmentation) | Event Ids |
| timestamp/2017 Sep. 24 | 850006245121695744, |
| | 850006245121695764, |
| | 850006245121695801 |
| timestamp/2017 Sep. 25 | 850006245121695882, |
| | 850006245121695951 |

d. Probabilistic Cardinality Estimation-Variables Created for Segmentation and Further Analytics.

| HLL Variables (relating to additional | |
|---|---|
| segmentation) | Event Ids |
| language/English | 850006245121695744, |
| | 850006245121695764, |
| | 850006245121695801, |
| | 850006245121695951 |
| language/Spanish | 850006245121695882 |
| user-location/Los_Angeles | 850006245121695744, |
| | 850006245121695801 |
| user-location/San_Juan | 850006245121695764 |
| user-location/Viegues | 850006245121695882, |
| | 850005245121695951 |

IV. Ontology Update and Enrichment.

As each event is processed from the event stream, co-reference count estimates are extracted for each entity pair-combination and individual entities. The existing ontology is updated and enriched with new entities or entity relations with significant cardinality estimates, i.e., above a predetermined threshold. For example, by observing references of the entity Hurricane Maria a significant number of times (e.g., over 100) the system determines to introduce it as a new entity to the ontology structure. Similarly, the associations to leptospirosis are observed a significant number of times (e.g., over 25) and are inserted as new associations to the existing ontology.

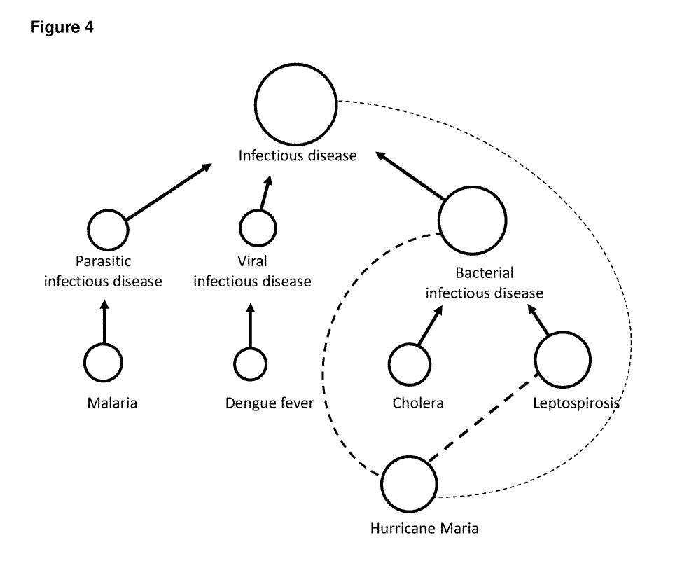

The above example is also illustrated in FIGS. 3 and 4. A temporal snapshot of a fragmented domain ontology regarding infectious diseases is shown in FIG. 3, which is the background ontology for FIG. 4. By processing Twitter messages as events regarding hurricanes and bacterial infection outbreaks, FIG. 4 shows the updated ontology with a new entity (“Hurricane Maria”) and new associations. The varied radii of the nodes represent the weight or significance levels of the entities based on cardinality estimates. The varied widths of the edges (solid and dashed lines) indicate the event-based cardinality estimates of the relevant associations.

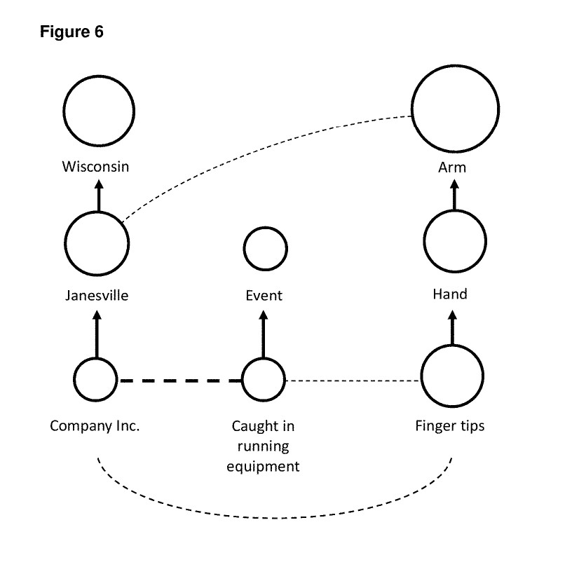

A further example for event-driven ontology updates is shown in FIG. 6. This is a temporal snapshot of the same domain ontology as shown in FIG. 5 regarding manufacturing and labor inspection. The events in this example are accidents reported to a labor inspection authority. Through cardinality estimates of companies, accident types and body parts referenced in these events, new associations or relations are introduced to the existing domain ontology based on co-reference counts (shown as dashed lines in FIG. 6)). The varied radii of the nodes represent the weight or significance levels of the entities based on cardinality estimates. The varied widths of the dashed edges indicate event-based cardinality estimates of the relevant associations.

### Past and Future Temporal Views of Knowledge Graph

The knowledge graph of this disclosure captures temporal information associated with the underlying domain ontology. In one embodiment, the system includes a graph analytics module adapted to traverse the graph database and identify entities and relationships of interest based on probabilistic cardinalities. The graph analytics module in a further embodiment is adapted to provide snapshots in the past of the knowledge graph as well as projected future views. Time series are created for interested entities or relationships in the knowledge graph according to additional embodiments to provide further insight on possible trends and changes in the domain ontology.

Accordingly, the knowledge graph system of this disclosure enables users to query entities and associations at a designated time in the past and to forecast the status of entities and associations at a future time of interest.

A user interface (UI) is provided as part of the knowledge graph system in an additional embodiment, capable of presenting content of interest to a user. The UI is connected to the graph analytics module. The UI-delivered content is textual, graphics, voice-based, or multi-media in various embodiments, and may include information about the entities, their relationships, and further analytics regarding the entities and relationships including time series data. In alternative embodiments, one or both of “push” and “pull” strategies are enabled to send content to users. In a certain embodiment, the user interface is adapted to receive a query from the user, and the content is responsive to the query. In further embodiments, the user interface is a smart phone, an augmented reality and/or virtual reality (AR/VR) device, a web browser, or a robotic assistant that is connected into the system.

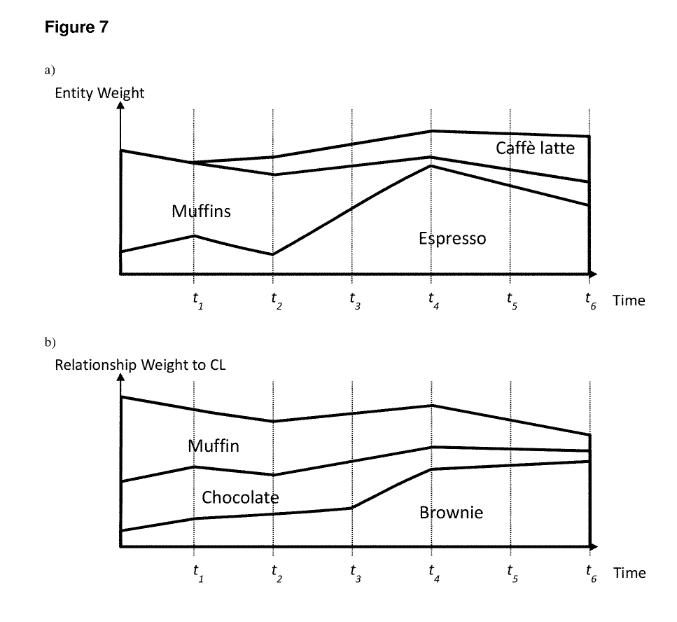

Referring to FIG. 7, a time series of a dynamic knowledge graph for sales in a coffee café is shown. The drawings in (a) and (b) are stacked area charts over time for sales of certain beverage and food products. Referring to FIG. 7(a), the height of each area represents estimated event cardinalities or event weights at given time points. Snapshots regarding the sales of any particular items can be obtained at any given time from these drawing. In addition, any possible coordination in the sales data between and among products may be ascertained by analyzing and querying the time series. For example, referring to FIG. 7(b), the Y-axis here represents the weight of the relationship between each of products and caffé latte (CL) which is charted in FIG. 7(a). These weighs are derived from probabilistic cardinalities estimated in this knowledge graph system relating to coffee shop sales. Based on the time series of the changing relationship weights specific to CL, it is shown here that those who have purchased caffé latte are increasingly also buying a brownie.

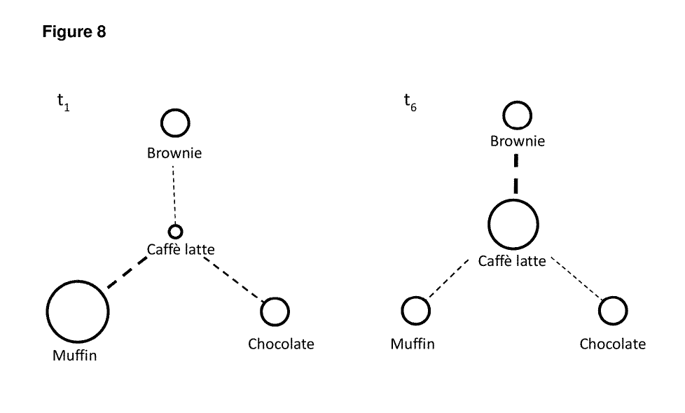

The same knowledge graph system for sales in a coffee café is further illustrated in FIG. 8. The snapshots taken with the timestamp t1 and t6 of the sales data as shown in FIG. 7 are presented here. The nodes represent the products as entities and the edges represent the relationships between the products, i.e., that their sales are coordinated. The radius of the nodes and the width of the edges indicate event-based cardinality estimates of the frequencies (or weights) at which the products are bought and bought together at particular time points. Based on the temporal views at t1 and t6 by the knowledge graph system, therefore, how the weights of the entities and their relationships evolve are clearly visualized: From t1 to t6, the overall sales of muffins are significantly reduced while the sales of caffé latte has increased. The sales of brownies are stable from t1 to t6, while caffé latte and brownies are increasingly bought together towards t6.

In similar manners, the time series over entities and relationships also enable extrapolation and provide projections of sales and their possible coordination for any particular products or product groups in the café for a particular time or period of time in the future.

The descriptions of the various embodiments, including the drawings and examples, are to exemplify and not to limit the invention and the various embodiments thereof.

We claim:

1. A system of dynamic knowledge graph, comprising: a cardinality approximator adapted to process a plurality of events thereby estimating probabilistic cardinalities for the plurality of events; and, a graph database adapted to provide an ontology for a knowledge domain corresponding to the plurality of events and to store information regarding the knowledge domain, wherein each event in the plurality is associated with a timestamp, and wherein the graph database is continuously updated based on the plurality of events.

2. The system of claim 1, wherein the ontology for the knowledge domain is initially imported to the graph database.

3. The system of claim 1, wherein the ontology for the knowledge domain is initially constructed from processing the plurality of events.

4. The system of claim 1, wherein the plurality of events comprises a first stream of events sequentially observed, and wherein the cardinality approximator is adapted to calculate the probabilistic cardinalities for the first stream of events.

5. The system of claim 4, wherein the plurality of events further comprises a second stream of events sequentially observed, and wherein the cardinality approximator is further adapted to calculate the probabilistic cardinalities for the second stream of events.

6. The system of claim 1, wherein the cardinality approximator utilizes one of Hyper LogLog, Hyper LogLog++, Sliding Hyper Log Log, and Log Log.

7. The system of claim 1, wherein each event is associated with at least one entity recognized by the ontology, wherein the probabilistic cardinalities for the plurality of events comprises a probabilistic cardinality for the entity.

8. The system of claim 7, wherein the graph database is further adapted to evolve the ontology by incorporating a previously-unrecognized entity associated with a timestamped event of the plurality, wherein the cardinality approximator is further adapted to estimate a probabilistic cardinality for the previously-unrecognized entity.

9. The system of claim 1, further comprising an event archive adapted to store information regarding the plurality of events.

10. The system of claim 1, wherein the knowledge domain consists of one of the financial information domain, the social media domain, the e-commerce domain, the law enforcement domain, the manufacturing and labor inspection domain, the medical and pharmaceutical domain, and climate sciences domain.

11. The system of claim 1, further comprising a graph analytics module adapted to traverse the graph database and identify entities and relationships based on probabilistic cardinalities.

12. The system of claim 11, wherein the graph analytics module is further adapted to generate a snapshot of the graph database at a predetermined time in the past.

13. The system of claim 11, wherein the graph analytics module is further adapted to generate a time series on an entity of the ontology thereby estimating a trend up to a predetermined time in the future for the entity.

14. The system of claim 11, further comprising a user interface adapted to present content to a user, wherein the content is one of text, graphic, voice, and multi-media.

15. The system of claim 14, wherein the user interface is adapted to receive a query from the user, and wherein the content is a response to the query.

16. The system of claim 14, wherein the user interface is one of a smart phone, an AR/VR device, a web browser, and a robotic assistant.

17. A method for dynamically updating a knowledge graph based an underlying ontology for a knowledge domain, comprising: collecting a plurality of events corresponding to the knowledge domain, wherein each event in the plurality has a timestamp and is associated with at least one entity recognized in the ontology; estimating a probabilistic cardinality for the at least one entity associated with each event in the plurality; and, updating the knowledge graph by incorporating the corresponding probabilistic cardinalities for the entities recognized in the ontology.

18. The method of claim 17, further comprising incorporating a previously-unrecognized entity associated with a timestamped event of the plurality and estimating a probabilistic cardinality for the previously-unrecognized entity, thereby updating the ontology of the knowledge domain.

19. The method of claim 17, wherein collecting a plurality of events further comprising collecting a first stream of events sequentially observed based on their corresponding timestamps, and wherein the knowledge graph is continually updated based on the first stream of events.

20. The method of claim 17, further comprising collecting a second stream of events sequentially observed based on their corresponding timestamps, and wherein the knowledge graph is continually updated based on the first and the second streams of events.

21. The method of claim 17, wherein the knowledge domain the knowledge domain consists of one of the financial information domain, the social media domain, the e-commerce domain, the law enforcement domain, the manufacturing and labor inspection domain, the medical and pharmaceutical domain, and climate sciences domain.

22. The method of claim 17, further comprising generating a snapshot of the knowledge graph at a predetermined time in the past.

23. The method of claim 17, further comprising generating a time series on an entity of the ontology thereby estimating a trend up to a predetermined time in the future for the entity.
